(19) United States
(12) Patent Application Publication
(10) Pub. No.: US 2013/0224627 A1
(43) Pub. Date: Aug. 29, 2013

(54) SCANDIUM-DOPED BZCY ELECTROLYTES

(71) Applicants: Mingfei LIU, Atlanta, GA (US); Meilin LIU, Alpharetta, GA (US); Ting HE, Bartlesville, OK (US)

(72) Inventors: Mingfei LIU, Atlanta, GA (US); Meilin LIU, Alpharetta, GA (US); Ting HE, Bartlesville, OK (US)

(73) Assignees: Georgia Tech Research Corporation, Atlanta, GA (US); Phillips 66 Company, Houston, TX (US)

(21) Appl. No.: 13/610,055

(22) Filed: Sep. 11, 2012

Related U.S. Application Data
(60) Provisional application No. 61/540,302, filed on Sep. 28, 2011.

(51) Int. Cl. H01M 8/12; B02C 17/00; F27D 7/00

(52) U.S. Cl. 429/489; 241/27; 432/23; 432/77

(57) ABSTRACT

The present invention discloses a novel scandium-doped Ba(Ce, Zr, Y)O_{3-δ} electrolyte for solid oxide fuel cells that exhibits elevated ion conductivity at intermediate temperature range comparing to other electrolyte materials, such as BZCYYb.

### PRIORITY CLAIM

This application claims priority to U.S. Ser. No. 61/540,302, filed Sep. 28, 2011, and expressly incorporated by reference in its entirety herein.

### FIELD OF THE INVENTION

The invention relates to a scandium-doped proton type electrolyte material for a solid oxide fuel cell, and particularly to a scandium-doped BZCY electrolyte that has twice the conductivity of BZCY.

### BACKGROUND OF THE INVENTION

The demand for clean, secure, and renewable energy has stimulated great interest in fuel cells. A fuel cell is a device that converts chemical energy from a fuel into electricity through a chemical reaction with oxygen or another oxidizing agent. Fuel cells are different from batteries in that they require a constant source of fuel and oxygen to run, but they can produce electricity continually as long as these inputs are supplied.

There are many types of fuel cells, but they all consist of an anode (negative side), a cathode (positive side) and an electrolyte therebetween that allows charges to move between the two sides of the fuel cell. Electrons are drawn from the anode to the cathode through an external circuit, producing direct current electricity.

The main difference between the various types of fuel cell is the electrolyte. Thus, fuel cells are classified by the type of electrolyte they use. There are many different types, including molten carbonate fuel cells (MCFC), phosphoric acid fuel cells (PAFC), alkaline fuel cells (AFC), polymer electrolyte membrane fuel cells (PEMFC), and many more.

Solid Oxide Fuel Cells (SOFCs) are a type of fuel cell that use a solid oxide or ceramic as the electrolyte of a cell. SOFCs are also known as high temperature fuel cells because the solid phase electrolytes usually do not show acceptable conductivity until they reach a high temperature of 800-1000° C.

The solid oxide fuel cell is made of three ceramic layers (hence the name), including a porous cathode, and electrolyte, and a porous anode. A fourth layer is the interconnect layer, which is used to stack multiple fuel cells together. Hundreds of the single cells are typically connected in series or parallel to form what most people refer to as an “SOFC stack.” A basic SOFC is shown in FIG. 1, which illustrates a single cell in FIG. 1A and a stack of cells in FIG. 1B.

One of the important benefits of SOFCs is that SOFC systems can run on fuels other than pure hydrogen gas. This is because the high operating temperatures allow SOFCs to internally reforming light hydrocarbons, such as methane (natural gas), propane and butane to form the H₂ needed for the fuel cell reactions. Heavier hydrocarbons including gasoline, diesel, jet fuel and biofuels can also serve as fuels in a SOFC system, but usually an upstream external reformer is required.

Among the many types of fuel cells, the SOFCs represent the cleanest, most efficient, and versatile energy conversion system, offering the prospect of efficient and cost effective utilization of hydrocarbon fuels, coal gas, biomass, and other renewable fuels. However, SOFCs must be economically competitive to be commercially viable and high operating temperatures and expensive materials contribute to significant cost.

One approach to cost reduction is to drastically reduce the operating temperature to 400-700° C., thereby allowing the use of much less expensive materials in the components and improving system longevity. Unfortunately, lowering the operating temperature also lowers the fuel cell performance, as the electrode and electrolyte materials become less conductive and less catalytically active.

Long term performance of SOFCs also degrades due to poisoning of the cathode by chromium from interconnect layers, deactivation of the conventional anode by carbon deposition, and poisoning by contaminants (e.g., sulfur) in the fuel gas.

Oxygen ion conductors are the conventional conductors for electrolyte use in SOFC (see e.g. the reactions shown FIG. 1A). However, today both proton and mixed ion conductors are also available for SOFC use. Proton-conducting electrolytes have the advantages of high proton conductivity and low activation energy at intermediate temperatures, which may widen up the selection of materials to be used in SOFC. Additional advantages of proton-conducting electrolytes include water being generated in the cathode side of the SOFC, thus avoiding fuel dilution at the anode side. The reaction chemistry and examples of oxygen-ion conductors and proton conductors are shown in Table 1:

TABLE 1
Oxygen ion and proton conductors

| Type of | | |
|---|---|---|
| conductor | Oxygen ion | Proton |
| Anode | H₂ + O²⁻ → H₂O + 2e−/ | H₂ → 2H⁺ + 2e− |
| | CO + O²⁻ → CO2 + 2e− | |
| Cathode | O₂ + 4e⁻ → 2O²⁻ | 2H⁺ + 2e⁻ + ½O₂ → H₂O |
| Overall | 2H₂ + O₂ → 2H₂O/ | 2H₂ + O₂ → 2H₂O |
| | 2CO + O₂→ 2CO₂ | |
| Advantages | H₂O, CO₂ and high temperatures at | No fuel dilution |
| | anode (fuel side) facilitates reforming of | Intermediate operating temperature |
| | hydrocarbon fuels to H₂ and CO | |
| Disadvantages | High operating temperature degrades | Reforming at anode (fuel side) lost |
| | system components and adds to cost | |
| | H₂O formed at anode dilutes fuel | |
| Examples | yttria-stabilized zirconia (YSZ) | yttria-doped BaZrO₃ (BYZ) |
| | samarium doped ceria (SDC) | calcium-doped lanthanum niobate |
| | gadolinium doped ceria (GDC) | (LCaNb) |
| | scandia stabilized zirconia (ScSZ) | Y-doped BaCeO₃ (BCY) |
| | strontium and magnesium doped | barium-zirconium-cerium-yttrium |
| | lanthanum gallate (LSGM) | (BZCY) |
| | | barium-zirconium-cerium-yttrium |
| | | ytterbium (BZCYYb) |
| | | scandia doped BZCY (BZCYSc) |

The third option is to tailor the proton and oxygen ion transference number of the mixed ion conductor, allowing CO₂ to form on the fuel side while allowing most of the H₂O to form on the air side. The class of mixed proton and oxygen ion conductors holds great potential for a new generation of low temperature SOFCs. However, to date the ideal mixed ionic conductor has not been found.

Thus, in order to make SOFCs fully fuel-flexible and cost-effective power systems, the issues of anode tolerance to coking and sulfur poisoning, slow ionic conduction in the electrolyte and sluggish kinetics at the cathode need to be addressed. In a broader scientific context, the chemical and electrochemical mechanisms that lead to both of these issues and the phenomena that could prevent them should be investigated in order to best optimize the materials and microstructure of SOFCs for excellent performance and stability.

BaCeO₃-based proton-conducting electrolytes are potential candidates for SOFC use. However, the poor chemical stability and the tendency to react with water vapor or carbon dioxide at high temperature, which in turn yield insulative barium carbonate that detrimentally affect the cell performance, makes BaCeO₃ a less desirable material for electrolyte.

BaZrO₃, especially acceptor-doped BaZrO₃, has substantial chemical stability against water vapor and carbon dioxide. Y₂O₃-doped BaZrO₃ (BZY), for example, was shown to have very high proton conductivity. In US20100112408, it was shown that BZCY has better ion conductivity than YSZ, especially in the lower temperature ranges, as shown in FIG. 2. In US20110195342, BaZr_{0.1}Ce_{0.7}Y_{0.2}O_{3-δ} (BZCY) was shown to reach power density of 162 and 318 mW/cm² when the operating temperatures were 650 and 750° C., respectively. It has been reported to have conductivity for low area specific resistance of 0.39 Ω·cm² and peak power density at 0.683 W·cm⁻² at 700° C.

Perovskite structures are the crystal structure of the prevailing electrode materials. A perovskite structure is a cubic crystal structure, like calcium titanium oxide (CaTiO3), or ^{XII}A^{2+VI}B⁴⁺X²⁻₃ with the oxygen in the face centers. Several of the above mentioned materials also have a perovksite structure with chemical formula ABX₃, wherein the A and B atoms are cations with different sizes and X is an anion bonding to each cation. Usually the A atom is larger than the B atom, and the relative ion size is crucial to the stability of the resulting structure. An example with ABC₃ is shown in FIG. 3. To alter the physical and chemical properties of a perovskite substance, doping at either A or B site of the structure has been attempted. For example, B-site dopants may include scandium, ytterbium, yttrium, gadolinium, samarium, etc.

Scandium-doped zirconia has been reported to have high conductivity, and therefore having high output potential. For example, US2008261099, US2008286625, US20090148742, and US20100167169 are amongst some of the patents mentioning scandium-doped zirconia. However, those scandium-doped zirconia are less stable than the conventional materials, and may incur the problems like reacting with cathode material.

Therefore, there is still the need for an electrolyte material that can provide higher ion conductivity at lower temperatures, especially at temperatures lower than 650° C., while maintaining the chemical stability, so as to allow wider choice of materials in SOFC design that may in turn reduces the fabrication cost and improves the cell reliability and performance.

### SUMMARY OF THE INVENTION

The present invention provides a novel electrolyte material for SOFC that has increased ion conductivity especially in the intermediate temperature range between 400 and 750° C. The novel electrolyte material comprises Ba(Ce, Zr, Y)O₃ doped with additional rare metals, especially scandium.

The present invention further provides a novel electrolyte material for a SOFC, in which the conductivity under both oxygen and hydrogen are much higher than that of the well developed BZCY and BZCYYb electrolytes. In some instances, the ionic conductivity of the scandium-doped BZCY electrolyte can be about two-fold or more higher than BZCY only electrolyte. Additionally, the higher conductivity of scandium-doped BZCY electrolyte at lower temperatures makes it a suitable candidate for intermediate temperature SOFCs.

Although not yet tested, it is likely that the above invention can be applied to any of the other known proton based electrolytes, especially the related electrolyte containing some of the same elements. Thus, the invention is expected to be applicable to BZY, BCY, BZCY, BZCYYb, and may also be applicable to unrelated proton type electrolytes such as LCaNb.

The following abbreviations are used herein:

| | |
|---|---|
| XRD | X ray diffraction |
| SOFC | Solid oxide fuel cell |
| YSZ | Yttria-stabilized zirconia |
| SSZ | Scandia-stabilized zirconia |
| BZY | BaZr_{1-y}Y_{y}O_{3-δ} |
| BCY | BaCe_{1-y}Y_{y}O_{3-δ} |
| BZCYYb | BaZr_{1-x-y-z}CeₓY_{y}Yb_{z}O_{3-δ} |
| BZCY | BaZr_{1-x-y}CeₓY_{y}O_{3-δ} |
| BZCY-Sc | BaCe_{1-x-y-z}ZrₓY_{y}Sc_{z}O_{3-δ} |

Where x, y, z are the dopant levels and must add up to less than 1, and delta is the oxygen ion deficit

As used herein “BZCY” represents BaZr_{1-x-y}CeₓY_{y}O_{3-δ}.

As used herein, “solid-state reaction” refers to reactions that do not require solvent. Solid-state reactions can include oven techniques and melt techniques.

The use of the word “a” or “an” when used in conjunction with the term “comprising” in the claims or the specification means one or more than one, unless the context dictates otherwise.

The term “about” means the stated value plus or minus the margin of error of measurement indicated or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

### BRIEF DESCRIPTION OF THE DRAWINGS

FIG. 1A is a single SOFC cell, while FIG. 1B shows a stack of more than one cell (less than two complete cells shown).

FIG. 2 is the conductivity versus temperature of some common oxygen ion type and proton type electrolytes, illustrating the superior conductivity of the proton-type electrolytes.

FIG. 3 shows an ideal perovskite structure illustrated for ABO₃. Note the corner-shared octahedra, extending in three dimensions.

FIG. 4 is the XRD pattern of BaZr_{0.1}Ce_{0.7}Y_{0.1}Sc_{0.1}O as prepared by the present invention.

FIG. 5 compares the ion conductivity of BaCe_{0.7}Zr_{0.1}Y_{0.1}Yb_{0.1}O_{3-δ} in air, BaCe_{0.7}Zr_{0.1}Y_{0.2}O_{3-δ} in air, and BaCe_{0.7}Zr_{0.1}Y_{0.1}Sc_{0.1}O_{3-δ} in air, dry H₂ and wet H₂ at temperatures between 400 and 750° C.

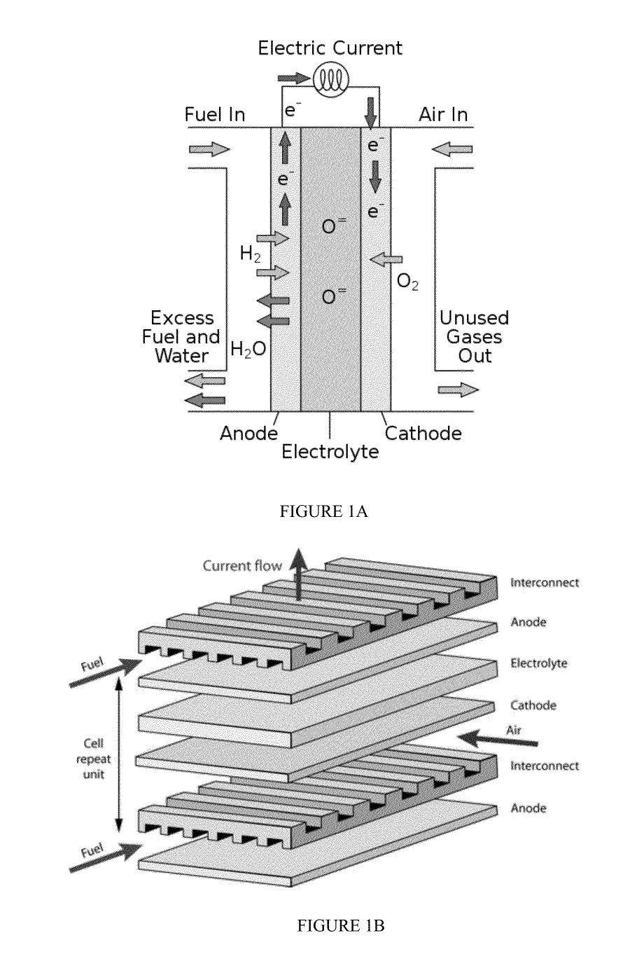

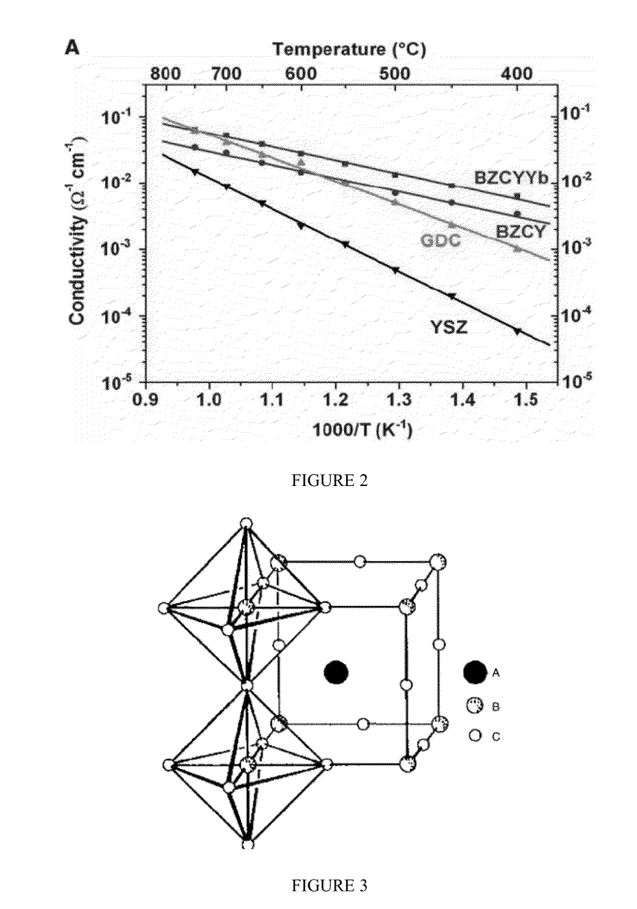

### DESCRIPTION OF EMBODIMENTS OF THE INVENTION

Generally speaking, the invention provides scandium doped proton type solid electrolyte, their use in fuel cells, and methods of making same. The proton type electrolyte is selected from the group consisting of BZY, BCY, BZCY, and BZCYYb, and possibly unrelated electrolytes such as LCaNb.

In another embodiment, the invention is a solid phase electrolyte for use in a fuel cell, the electrolyte comprising BaCe_{1-x-y-z-w}ZrₓY_{y}Sc_{z}Yb_{w}O_{3-δ}, wherein x, y, z and w are dopant levels between 0 to 1 and x+y+z+w<1 and 8 is the oxygen ion deficit.

The amount of scandium can vary, thus z can range from 0.1-0.5, or higher, and can be lower in the range of about or 0.01-0.1.

In particularly preferred embodiments, the electrolyte is BZCY—Sc, and especially preferred is BaZr_{0.1}Ce_{0.7}Y_{0.1}Sc_{0.1}O_{3-δ}.

The scandium-doped electrolytes of the invention have at least double the conductivity of control electrolytes not doped with scandium, under the same conditions at temperatures from 550-700° C.

Methods of making a scandium-doped electrolytes are also provided, comprising the steps of mixing stoichiometric amounts of barium carbonate, zirconium oxide, cerium oxide, yttrium oxide, ytterbium oxide and scandium oxide powders; milling the mixture; calcining the mixture; and, optionally, repeating the milling and calcining steps. Other steps, such as wash and dry steps, can also be included in the method but are not needed.

The stoichiometric amounts of each ingredient are as desired per the formulae provided herein.

Solid oxide fuel cells comprising any of the above electrolytes are also provided. More particularly, the SOFC comprises a cathode adjacent an electrolyte adjacent an anode, wherein the electrolyte comprises a scandium doped electrolyte as described herein.

The SOFCs can be of any desired format including stacked planar cells and tubular formats. Further, the materials for the anode and cathode can be chosen from any of the known or future developed materials, provided that they are compatible with each other and the novel electrolytes provided herein, and provide maximum longevity and efficiencies balanced against cost.

The interconnect can be either a metallic or ceramic layer or combination that sits between each individual cell and is shaped to allow gas flow therethrough, as well as to provide electrical contact between cells. Because the interconnect is exposed to both the oxidizing and reducing side of the cell at high temperatures, it must be extremely stable. For this reason, ceramics have been more successful in the long term than metals as interconnect materials. However, these ceramic interconnect materials are very expensive as compared to metals, and nickel- and steel-based alloys are becoming more promising as lower temperature (600-800° C.) SOFCs are developed.

The following detailed discussions are illustrative only, and are not intended to unduly limit the scope of the invention.

### Preparing Sc-Doped BZCY

BZCY—Sc with a nominal composition of BaCe_{0.7}Zr_{0.1}Y_{0.1}Sc_{0.1}O_{3-δ} (BZCY—Sc) was synthesized by a conventional solid-state reaction (SSR) method. Stoichometric amounts on a molar basis of high-purity barium carbonate, zirconium oxide, cerium oxide, yttrium oxide and scandium oxide powders (BaCO₃:ZrO2:CeO₂:Y₂O₃:Sc₂O₃=167.33:12.32:120.48:22.58:13.79, all from SIGMA ALDRICH CHEMICALS™) were mixed by ball milling in ethanol for 24 hours, followed by drying at 80° C. for overnight and calcinations at 1100 C in air for 10 hours. The calcined powder was ball milled again, followed by another calcination at 1100 C in air for 10 hours to produce single phase BZCY—Sc.

### Testing Conductivity

The as prepared electrolyte powders were dry pressed into a disk under 275 MPa, followed by sintering at 1450 C for 5 h to get dense pellets (around 1 mm thick). After polishing the electrolyte surface, platinum paste was then applied to both sides of electrolyte disks and fired at 850° C. for 1 hour to form porous platinum electrodes. Two platinum wires were attached to each of the electrodes. The electrical conductivities were studied in air and H₂ at various temperatures.

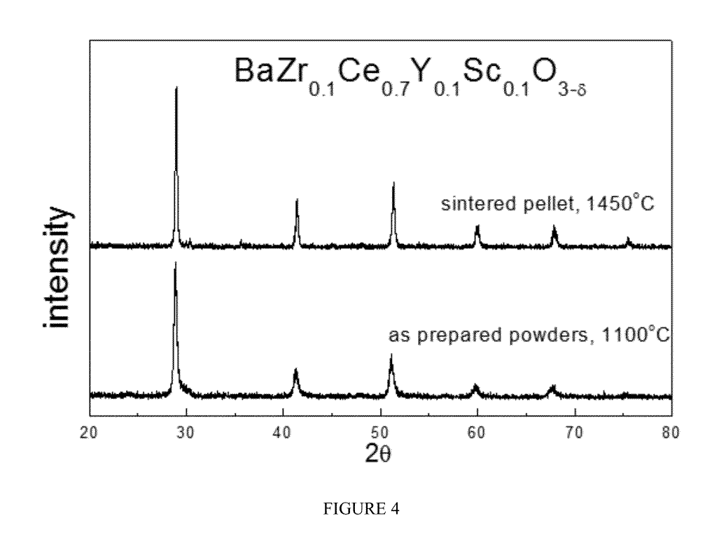

FIG. 4 shows the XRD patterns of the as prepared BZCY—Sc powder and the sintered pellet. The diffraction peaks of the BZCY—Sc can be indexed based on a perovskite structure with cubic lattice symmetry, and no impurity phase was detected. These results suggest that Sc was successfully doped into the B-site of BZCY system to produce a homologous phase of BZCY—Sc.

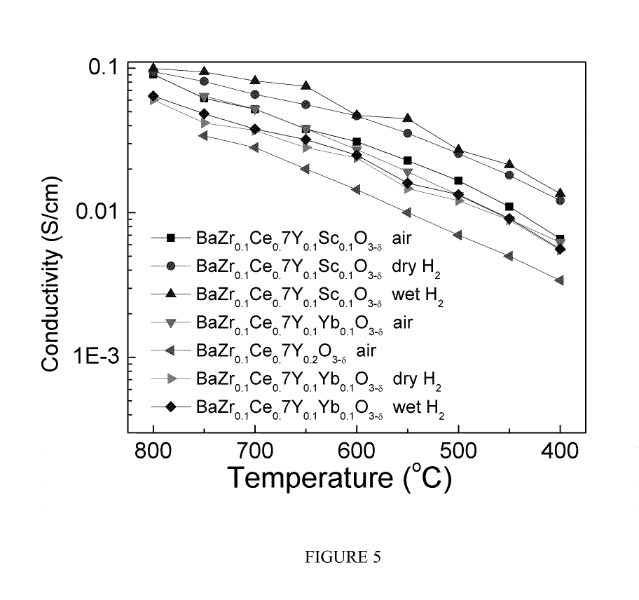

FIG. 5 shows the electrical conductivity of BZCY—Sc sample measured at different conditions. It can be seen that enhanced conductivity was observed in the scandium-doped BZCY compared to BZCYYb, especially under reducing conditions. At 600° C., conductivity of BZCY—Sc reached 0.046 and 0.057 S/cm in dry and wet H₂, respectively. As a comparison, BZCYYb in dry and wet H₂ showed approximately 0.023 and 0.027 S/cm at 600° C., respectively. The improvement in conductivity was two-fold. Thus, the scandium-doped electrolyte performed twice as well as the Yb doped electrolyte.

Similarly, at 550° C., the BZCY shows a conductivity of about 0.01 S/cm in air, versus about 0.022 for scandium-doped BZCY in air, a 2.2 fold increase. At 500 C, the BZCY shows a conductivity of about 0.007 S/cm in air, versus about 0.017 for scandium-doped BZCY in air, a 2.4 fold increase.

Therefore, the Sc doped electrolyte exhibits at least a doubling in ion conductivity compared to BZCY or the ytterbium-doped BZCY over an intermediate temperature range. This shows that the Sc-doped BZCY has great potential in being used as an electrolyte of SOFCs. The mechanism of conductivity enhancement through Sc doped at B-site, especially under reducing conditions, is still under study.

It is predicted that scandium can be used to dope related proton type electrolytes, including BZY, BCY, BZCY, and BZCYYb, and possibly others.

The following references are incorporated by reference in their entirety.
Nien et al., Preparation of BaZr_{0.1}Ce_{0.7}Y_{0.2}O_{3-δ} Based Solid Oxide Fuel Cells with Anode Functional Layers by Tape Casting, Fuel Cells, Volume 11, Issue 2, pp. 178-183, 2011.
US2010112408
US2011195342
US2008261099
US2008286625
US20090148742
US20100167169

What is claimed is:

1. The electrolyte for a fuel cell of claim 14, wherein the electrolyte has an ionic conductivity of at least 0.05 S/cm in wet H₂ at 600° C.

2. The electrolyte for a fuel cell of claim 14, wherein the electrolyte is BaZr_{0.1}Ce_{0.7}Y_{0.1}Sc_{0.1}O_{3-δ}.

3. The electrolyte for a fuel cell of claim 2, wherein the electrolyte has an ionic conductivity of at least 0.05 S/cm in wet H₂ at 600° C.

4. The electrolyte for a fuel cell of claim 2, where the electrolyte has twice the ion conductivity of a control electrolyte lacking scandium.

5. A method for making a scandium-doped BZCY electrolyte of claim 14, comprising the steps of:
a) mixing stoichiometric amounts of barium carbonate, zirconium oxide, cerium oxide, yttrium oxide and scandium oxide powders;
b) milling the mixture of powders from step a);
c) calcining the mixture from step b); and
d) optionally repeating steps b) to c) to produce the scandium-doped BZCY electrolyte.

6. The method of claim 5, wherein the scandium-doped BZCY electrolyte is BaCe_{1-x-y-z}ZrₓY_{y}Sc_{z}O_{3-δ}, wherein x, y and z are dopant levels from 0 to 1 and x+y+z<1 and δ is the oxygen ion deficit.

7. The method of claim 5, wherein the scandium-doped BZCY electrolyte is BaZr_{0.1}Ce_{0.7}Y_{0.1}Sc_{0.1}O_{3-δ}.

8. The method of claim 5, wherein the calcining step is carried out at 1100° C. in air for 10 hours.

9. The method of claim 5, wherein the cooling step is carried out in room temperature.

10. The method of claim 5, wherein the scandium-doped BZCY has an ionic conductivity of about 0.057 S/cm in wet H₂ at 600° C.

11. (canceled)

12. (canceled)

13. (canceled)

14. An electrolyte for a fuel cell comprising a scandium-doped BZCY electrolyte, wherein the scandium-doped BZCY electrolyte is BaCe_{1-x-y-z}ZrₓY_{y}Sc_{z}O_{3-δ}, wherein x, y and z are dopant levels from 0 to 1 and x+y+z<1 and δ is the oxygen ion deficit.

15. (canceled)

16. (canceled)

17. (canceled)

18. (canceled)

19. The electrolyte for a fuel cell of claim 5, where said electrolyte has twice the ion conductivity of a control electrolyte lacking scandium.

20. The electrolyte for a fuel cell of claim 14, where said electrolyte has twice the ion conductivity of a control electrolyte lacking scandium.
